(19) United States
(12) Patent Application Publication
(10) Pub. No.: US 2026/0313683 A1
(43) Pub. Date: Oct. 8, 2026

(54) METHOD AND APPARATUS FOR CONTENTION WINDOW SIZE ADJUSTMENT FOR PSFCH TRANSMISSION

(71) Applicant: LENOVO (BEIJING) LIMITED, Beijing (CN)

(72) Inventors: Haipeng LEI, Beijing (CN); Zhennian SUN, Beijing (CN); Xiaodong YU, Beijing (CN); Xin GUO, Beijing (CN)

(21) Appl. No.: 19/482,489

(22) PCT Filed: May 15, 2023
(86) PCT No.: PCT/CN2023/094255

§ 371 Date: Nov. 7, 2025

(51) Int. Cl. H04W 74/04; H04L 1/1812; H04L 1/1829

(52) U.S. Cl. CPC H04W 74/04; H04L 1/1812; H04L 1/1864

(57) ABSTRACT

Embodiments of the present disclosure relate to methods and apparatuses for contention window size (CWS) adjustment for PSFCH transmission over an unlicensed spectrum. According to some embodiments of the disclosure, a first UE may: receive, from a second UE, a first PSSCH; transmit, to the second UE, a first PSFCH carrying HARQ-ACK feedback for the first PSSCH; receive, from the second UE, a second PSSCH; determine, based on whether the first PSFCH is correctly received by the second UE or not, a second CWS for the first UE to perform a second channel access procedure for transmitting a second PSFCH carrying HARQ-ACK feedback for the second PSSCH; and perform the second channel access procedure using the second CWS.

### TECHNICAL FIELD

Embodiments of the present disclosure generally relate to wireless communication technology, and more particularly to contention window size adjustment for physical sidelink feedback channel (PSFCH) transmission over an unlicensed spectrum.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

A wireless communication system may also support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmission may be performed on a licensed spectrum and/or an unlicensed spectrum.

There is a need for handling sidelink transmissions on an unlicensed spectrum.

### SUMMARY

Some embodiments of the present disclosure provide a first user equipment (UE). The first UE may include a transceiver, and a processor coupled to the transceiver. The processor may be configured to: receive, from a second UE, a first physical sidelink shared channel (PSSCH); transmit, to the second UE, a first physical sidelink feedback channel (PSFCH) carrying hybrid automatic repeat request acknowledgement (HARQ-ACK) feedback for the first PSSCH; receive, from the second UE, a second PSSCH; determine, based on whether the first PSFCH is correctly received by the second UE or not, a second contention window size (CVWS) for the first UE to perform a second channel access procedure for transmitting a second PSFCH carrying HARQ-ACK feedback for the second PSSCH; and perform the second channel access procedure using the second CWS.

In some embodiments of the present disclosure, In some embodiments of the present disclosure, the processor may be further configured to: receive, from the second UE, a second sidelink control information (SCI) format scheduling the second PSSCH, wherein the second SCI format includes an indicator indicating whether at least one of previous PSFCHs including the first PSFCH transmitted by the first UE to the second UE in a latest channel occupancy is correctly received by the second UE or not; and wherein determining the second CWS may include determining the second CWS based on the indicator in the second SCI format.

In some embodiments of the present disclosure, the processor may be further configured to determine a first CWS for the first UE to perform a first channel access procedure for transmitting the first PSFCH. Determining the second CWS may include: setting a value of the second CWS to a minimum allowed CWS value for a channel access priority class (CAPC) value associated with the second channel access procedure in the case that the indicator indicates that at least one of the previous PSFCHs is correctly received by the second UE; or increasing a value of the first CWS to a next allowed CWS value among allowed CWS values for the CAPC value and setting the value of the second CWS to the increased value in the case that the indicator indicates that none of the previous PSFCHs is correctly received by the second UE.

In some embodiments of the present disclosure, the processor may be further configured to: receive, from the second UE, a second sidelink control information (SCI) format scheduling the second PSSCH, wherein the second SCI format includes an indicator indicating how to adjust the second CWS; and wherein determining the second CWS may include determining the second CWS based on the indicator in the second SCI format.

In some embodiments of the present disclosure, the processor may be further configured to determine a first CWS for the first UE to perform a first channel access procedure for transmitting the first PSFCH. Determining the second CWS may include: setting a value of the second CWS to a minimum allowed CWS value for a channel access priority class (CAPC) value associated with the second channel access procedure in the case that the indicator indicates a CWS reset; or increasing a value of the first CWS to a next allowed CWS value among allowed CWS values for the CAPC value and setting the value of the second CWS to the increased value in the case that the indicator indicates to a CWS increase.

Some embodiments of the present disclosure provide a second UE. The second UE may include a transceiver, and a processor coupled to the transceiver. The processor may be configured to: transmit, to a first UE, a first PSSCH; transmit, to the first UE, a second sidelink control information (SCI) format scheduling a second PSSCH, wherein the second SCI format includes an indicator indicating how to adjust a second CWS for the first UE to perform a second channel access procedure for transmitting a second PSFCH carrying HARQ-ACK feedback for the second PSSCH, and wherein the indicator is determined based on whether a first PSFCH carrying HARQ-ACK feedback for the first PSSCH is correctly received by the second UE or not; and transmit, to the first UE, the second PSSCH.

In some embodiments of the present disclosure, the processor may be further configured to transmit, to the first UE, a first SCI format scheduling the first PSSCH, wherein the first SCI format indicates that a first channel access procedure for transmitting the first PSFCH uses a minimum allowed CWS value for a channel access priority class (CAPC) value associated with the first channel access procedure.

Some embodiments of the present disclosure provide a first user equipment (UE). The first UE may include a transceiver, and a processor coupled to the transceiver. The processor may be configured to: receive, from a second UE, a PSSCH; determine, based on a default setting or an occupancy state of a channel, a CWS for the first UE to perform a channel access procedure for transmitting a PSFCH carrying HARQ-ACK feedback for the PSSCH; perform the channel access procedure on the channel using the CWS; and transmit, to the second UE, the PSFCH in response to the channel access procedure being successful.

Some embodiments of the present disclosure provide a method for sidelink transmission. The method may be performed by a first UE. The method may include: receiving, from a second UE, a first PSSCH; transmitting, to the second UE, a first PSFCH carrying HARQ-ACK feedback for the first PSSCH; receiving, from the second UE, a second PSSCH; determining, based on whether the first PSFCH is correctly received by the second UE or not, a second CWS for the first UE to perform a second channel access procedure for transmitting a second PSFCH carrying HARQ-ACK feedback for the second PSSCH; and performing the second channel access procedure using the second CWS.

Some embodiments of the present disclosure provide a method for sidelink transmission. The method may be performed by a second UE. The method may include: transmitting, to a first UE, a first PSSCH; transmitting, to the first UE, a second SCI format scheduling a second PSSCH, wherein the second SCI format includes an indicator indicating how to adjust a second CWS for the first UE to perform a second channel access procedure for transmitting a second PSFCH carrying HARQ-ACK feedback for the second PSSCH, and wherein the indicator is determined based on whether a first PSFCH carrying HARQ-ACK feedback for the first PSSCH is correctly received by the second UE or not; and transmitting, to the first UE, the second PSSCH.

Some embodiments of the present disclosure provide a method for sidelink transmission. The method may be performed by a first UE. The method may include: receiving, from a second UE, a PSSCH; determining, based on a default setting or an occupancy state of a channel, a CWS for the first UE to perform a channel access procedure for transmitting a PSFCH carrying HARQ-ACK feedback for the PSSCH; performing the channel access procedure on the channel using the CWS; and transmitting, to the second UE, the PSFCH in response to the channel access procedure being successful.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an example of sidelink transmissions on an unlicensed spectrum in accordance with some embodiments of the present disclosure;

FIGS. 3-5 illustrate flow charts of exemplary procedures for sidelink communications on an unlicensed spectrum in accordance with some embodiments of the present disclosure; and

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

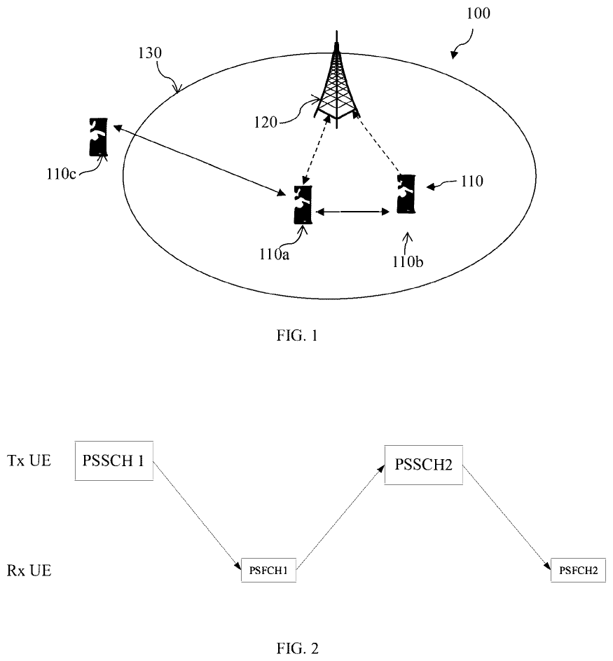

FIG. 1 illustrates a schematic diagram of a wireless communication system 100 in accordance with some embodiments of the present disclosure.

As shown in FIG. 1, wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a. UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1).

Sidelink transmission may involve a physical sidelink control channel (PSCCH) and an associated physical sidelink shared channel (PSSCH), which is scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE). The PSSCH may carry data which may require corresponding hybrid automatic repeat request acknowledgement (HARQ-ACK) feedback from the Rx UE(s) to the Tx UE. The HARQ-ACK feedback for a PSSCH may be carried on a physical sidelink feedback channel (PSFCH). In the contexts of the present disclosure, “PSCCH,” “SCI,” and “SCI format” may be used interchangeably.

In some embodiments of the present disclosure, sidelink transmission may be performed on an unlicensed spectrum. This is advantageous because a sidelink transmission over an unlicensed spectrum can achieve, for example, an increased data rate(s). In order to achieve fair coexistence between various systems, for example, NR systems (e.g., NR-U systems) and other wireless systems, a channel access procedure, also known as a listen-before-talk (LBT) test, may be performed before communicating on the unlicensed spectrum. When the channel access procedure is successful, a UE can start transmission on the channel and occupy the channel a certain channel occupancy time (COT). Otherwise, the UE cannot start the transmission and may continue to perform another channel access procedure until a successful result.

Various types of channel access procedure (e.g., Type 1 channel access procedure and Type 2 channel access procedure as specified in 3GPP specification) may be supported when communicating on the unlicensed spectrum.

For example, for a Type 2 channel access procedure, the LBT duration may be 16 us or at least 25 us. Therefore, the LBT duration can be confined within one symbol for 15 kHz or 30 kHz subcarrier spacing (SCS) or may be longer than one symbol for 60 kHz or larger SCS.

For example, for Type 1 channel access procedure, a random backoff counter is generated within a contention window (CW). The contention window size (CWS) can be determined based on a CAPC value which is corresponding to the transmitted data. The CWS may be dynamically adjusted burst by burst according to the HARQ-ACK feedback in the reference duration.

For example. Table 1 below shows a mapping between CAPC values and allowed CWS values (i.e., “allowed CWₚ sizes” in the table). CW_{min,p} and CW_{max,p} in the table respectively refer to the minimum and maximum CWSs of a corresponding CAPC. The definitions of mₚ and T_{uim cot,p} are specified in 3GPP specifications and are incorporated hereinto. Such table may be preconfigured or configured for a UE or predefined, for example, in a standard(s). It should be understood that Table 1 is only for illustrative purposes, and should not be construed as limiting the embodiments of the present disclosure.

TABLE 1
mapping between CAPC values and allowed CWSs

| CAPC | | | | | allowed |
|---|---|---|---|---|---|
| (p) | mₚ | CW_{min, p} | CW_{max, p} | T_{ulm cot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, |
| | | | | | 255, 511, 1023} |
| 4 | 7 | 15 | 1023 | 6 ms or 10 ms | {15, 31, 63, 127, |
| | | | | | 255, 511, 1023} |

NOTE 1:
For p = 3, 4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 μs. The maximum duration before including any such gap shall be 6 ms.

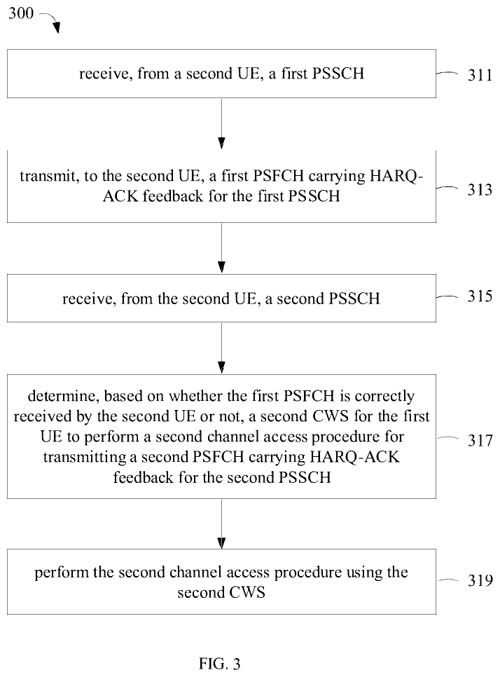

FIG. 2 illustrates an example of sidelink transmissions on an unlicensed spectrum in accordance with some embodiments of the present disclosure.

Referring to FIG. 2, a Tx UE may transmit a PSSCH (e.g., PSSCH 1 in FIG. 2) to an Rx UE in a unicast manner. The Rx UE may transmit a PSFCH (e.g., PSFCH 1 in FIG. 2) which carries HARQ-ACK feedback (e.g., 1 bit of ACK or NACK) for PSSCH 1 to the Tx UE. The Tx UE may further transmit another PSSCH (e.g., PSSCH 2 in FIG. 2) to the Rx UE using the same HARQ process number, same source ID and destination ID, the Rx UE may transmit a PSFCH (e.g., PSFCH 2 in FIG. 2) carrying HARQ-ACK feedback (e.g., 1 bit of ACK or NACK) for PSSCH 2 to the Tx UE.

In some embodiments of the present disclosure, before transmitting PSSCH 2 and its associated PSCCH to the Rx UE, the Tx UE may perform a Type-1 channel access procedure using a CWS (denoted as CWS #A1). In some embodiments of the present disclosure, it is proposed to adjust the CWS based on the feedback of a previous sidelink transmission(s). For example, the value of CWS #A1 may be adjusted based on HARQ-ACK feedback for PSSCH 1 (e.g., PSFCH 1).

In some embodiments of the present disclosure, the Rx UE may perform a Type-1 channel access procedure for transmitting PSFCH 1 using a CWS (denoted as CWS #B1, which can be the minimum CWS) according to CAPC p for this Type-1 channel access procedure. The Rx UE may also perform another Type-1 channel access procedure for transmitting PSFCH 2 using a CWS (denoted as CWS #B2). For example, the CAPC for the another Type-1 channel access procedure is also CAPC p. There is a problem of how to determine or adjust the CWS (e.g., CWS #B2) used for performing Type-1 channel access procedure because there is no HARQ-ACK feedback to the PSFCH transmitter UE (e.g., no HARQ-ACK feedback for PSFCH transmission (e.g., PSFCH 1) to the Rx UE).

The above problem also exists in various other scenarios, including for example: the scenario that groupcast option 2 is employed and a Tx UE transmits a PSCCH/PSSCH to a group of Rx UEs; the scenario that an Rx UE needs to transmit multiple PSFCHs in one PSFCH occasion; and the scenario that a Tx UE needs to perform a Type-1 channel access procedure for transmitting a synchronization signal block (SSB).

Embodiments of the present disclosure provide solutions to solve the above issues. For example, solutions for determining or adjusting CWS for transmitting a PSFCH or an SSB on an unlicensed spectrum are proposed. The proposed solutions can not only solve the above issues, but also avoid high implementation complexity at a UE and increase spectrum utilization efficiency. More details on the embodiments of the present disclosure will be illustrated in the following text in combination with the appended drawings.

In some embodiments of the present disclosure, a CWS for a UE (denoted as UE #1 which can be an Rx UE) to perform a channel access procedure for transmitting a PSFCH to another UE (denoted as UE #2 which can be a Tx UE) may be determined or adjusted based on whether a previously PSFCH(s) transmitted from UE #1 to UE #2 is correctly received by UE #2 or not.

In some embodiments. UE #1 may determine whether the transmitted previously PSFCH(s) is correctly received by UE #2 or not, and then determine or adjust the CWS based on the determination. In some embodiments. UE #2 may indicate whether the transmitted previously PSFCH(s) is correctly received by UE #2 or not, and UE #1 may determine or adjust the CWS based on the indication. In some embodiments, UE #2 may indicate how to determine or adjust the CWS, and UE #1 may determine or adjust the CWS based on the indication. More details on these embodiments will be illustrated in the following text.

In some embodiments of the present disclosure, for a unicast sidelink transmission from UE #2 to UE #1, assuming that UE #2 transmits a PSCCH (denoted as PSCCH #A1) and a PSSCH (denoted as PSSCH #A1) scheduled by PSCCH #A1, UE #1 uses a CWS (denotes as CW_{p,#A1}, where p is the corresponding CAPC value for the sidelink transmission) to perform a channel access procedure (denoted as LBT #A1 which may be a Type-1 channel access procedure) for transmitting a PSFCH (denoted as PSFCH #A1) carrying HARQ-ACK feedback corresponding to PSSCH #A1, in the case that UE #2 further transmits another PSCCH (denoted as PSCCH #A2) and another PSSCH (denoted as PSSCH #A2) scheduled by PSCCH #A2, then UE #1 may need to determine another CWS (denotes as CW_{p,#A2}) to perform another channel access procedure (denoted as LBT #A2 which may be a Type-1 channel access procedure) for transmitting a PSFCH (denoted as PSFCH #A2) carrying HARQ-ACK feedback corresponding to PSSCH #A2. The CAPC value p can also be referred to as the CAPC value associated with LBT #A1 or LBT #A2.

In some embodiments, CW_{p,#A2} may be determined based on information indicated in PSCCH #A1 and PSCCH #A2 (or put another way, based on information indicated in the SCI formats (denoted as SCI #A1 and SCI #A2) carried in PSCCH #A1 and PSCCH #A2). For example, the value of CW_{p,#A2} may be set (or reset) to the minimum allowed CWS value (denoted as CW_{p,min}) for CAPC value p, increased to the next allowed higher value relative to, for example, CW_{p,#A1}, or kept unchanged, for example, set as CW_{p,#A1}, according to the information in the SCI formats (e.g., according to the NDIs, HARQ process numbers, source IDs and destination IDs associated with PSSCH #A1 and PSSCH #A2 in the SCI formats). For example, UE #1 may use the NDIs and the HARQ-ACK feedback carried on PSFCH #A1 reported by UE #1 to determine whether PSCCH #A1 has been correctly decoded by UE #1 or not, and then determine or adjust the value of CW_{p,#A2} for transmitting PSFCH #A2.

For example, in response to receiving SCI format #A2 carried in PSCCH #A2, UE #1 may determine whether the HARQ process number, source ID and destination ID associated with PSSCH #A2 in SCI format #A2 are respectively the same as the corresponding fields (i.e., the HARQ process number, source ID and destination ID associated with PSSCH #A1) in SCI format #A1 carried in PSCCH #A1 (for simplicity, this step may also be referred to as a “prerequisite determination” hereinafter). In the case that the prerequisite determination is satisfied (i.e., the HARQ process number, the source ID and the destination ID associated with PSSCH #A2 are respectively the same as those associated with the PSSCH #A1), UE #1 may then determine how to determine or adjust the CW_{p,#A2} based on the NDIs in the SCI formats and the HARQ-ACK feedback carried on PSFCH #A1.

For example, in some embodiments, in the case that PSFCH #A1 carries an ACK for PSSCH #A1 and the NDI associated with PSSCH #A2 is toggled compared with the NDI associated with PSSCH #A1 (hereinafter, case #1), UE #1 may determine that PSSCH #A2 is a new transmission and PSFCH #A1 is correctly received by UE #2. In this case, LIE #1 may set (or reset) the CWS to the minimum value. i.e., CW_{p,#A2} may be equal to CW_{p,min}, and UE #1 may then use CW_{p,#A2} for performing LBT #A2 for transmitting PSFCH #A2. For example, referring to Table 1, assuming the CAPC value p is equal to 2, CW_{p,#A2} may be set to 7 which is the minimum value among the allowed CWS values {7, 15} for CAPC value 2.

In some embodiments, in the case that PSFCH #A1 carries an ACK for PSSCH #A1 and the NDI associated with PSSCH #A2 is non-toggled compared with the NDI associated with PSSCH #A1 (hereinafter, case #2), UE #1 may determine that PSSCH #A2 is a retransmission of PSSCH #A1 and PSFCH #A1 is not correctly received by UE #2. In this case. UE #1 may increase the CWS to the next allowed higher CWS value. For example, CW_{p,#A2} is set to the next allowed higher value compared with CW_{p,#A1} among the allowed CWS values for the CAPC value p. UE #1 may then use CW_{p,#A2} for performing LBT #A2 for transmitting PSFCH #A2.

For example, referring to Table 1, assuming the CAPC value p is equal to 3 and CW_{p,#A1} is equal to 15, CW_{p,#A2} may be set to 31 which is the next allowed CWS value among the allowed CWS values (15, 31, 63, 127, 255, 511, 1023) for CAPC value 3. For example, UE #1 may increase CW_{p,#A1} (e.g., 15) to the next allowed CWS value (e.g., 31) and set the value of CW_{p,#A2} to the increased value (e.g., 31).

In some embodiments, in the case that PSFCH #A1 carries a NACK for PSSCH #A1 and the NDI associated with PSSCH #A2 is non-toggled compared with the NDI associated with PSSCH #A1 (hereinafter, case #3). UE #1 may determine that PSSCH #A2 is a retransmission of PSSCH #A1. However, UE #1 cannot determine whether PSFCH #A1 is correctly received by UE #2 or not. In this case, various methods may be employed by UE #1 to determine the CWS (e.g., CW_{p,#A2}). UE #1 may then use the determined CWS (e.g., CW_{p,#A2}) for performing LBT #A2 for transmitting PSFCH #A2.

In some examples, UE #1 may assume that PSFCH #A1 is correctly received by UE #2. UE #1 may set (or reset) the CWS to the minimum allowed CWS value, i.e., CW_{p,#A2} may be equal to CW_{p,min}.

In some examples, UE #1 may assume that PSFCH #A1 is not correctly received by UE #2. UE #1 may increase the CWS to the next allowed higher value. For example, CW_{p,#A2} is the next allowed higher CWS value compared with CW_{p,#A1} among the allowed CWS values for the CAPC value p.

In some examples, UE #1 may keep the CWS unchanged. For example, CW_{p,#A2} is equal to CW_{p,#A1}.

In some examples, it is up to UE implementation to set CW_{p,#A2} to CW_{p,min}, the next allowed higher CWS value compared with CW_{p,#A1}, or CW_{p,#A1}. In other words, a UE can determine how to adjust the CWS at its own discretion.

When the prerequisite determination is satisfied, there may exist other cases in addition to the above cases #1 to #3. In all cases other than cases #1 to #3, UE #1 may keep the CWS unchanged. For example, CW_{p,#A2} is equal to CW_{p,#A1}. Alternative, UE #1 may set CW_{p,#A2} to CW_{p,min} or the next allowed higher CWS value compared with CW_{p,#A1}.

In some embodiments of the present disclosure, when a certain CWS is consecutively used a plurality of times (e.g., K times) for performing a channel access procedure for transmitting a PSFCH, the next allowed higher CWS value may be used. In some embodiments of the present disclosure, when the maximum allowed CWS value (denoted as CW_{p,max}) among the allowed CWS values for a certain CAPC value (e.g., CAPC value p) is consecutively used a plurality of times (e.g., K times) for perform a channel access procedure, the corresponding minimum allowed CWS value (e.g., CW_{p,min}) may be used for performing a channel access procedure for transmitting a PSFCH.

For example, in the case that the value of CW_{p,#A1} is consecutively used K times for performing a channel access procedure for transmitting a PSFCH, UE #1 may increase the CWS to the next allowed higher CWS value. For example, CW_{p,#A2} is set to the next allowed higher value compared with CW_{p,#A1} among the allowed CWS values for the CAPC value p. UE #1 may then use CW_{p,#A2} for performing LBT #A2 for transmitting PSFCH #A2.

For example, in the case that the value of CW_{p,#A1} is equal to CW_{p,max} and is consecutively used K times for performing a channel access procedure for transmitting a PSFCH, UE #1 may set CW_{p,#A2} to CW_{p,min}. UE #1 may then use CW_{p,min} for performing LBT #A2 for transmitting PSFCH #A2.

In some embodiments, the value of K may be preconfigured, configured by, for example, RRC signaling, or predefined, for example, in a standard(s). In some embodiments, the value of K may be equal to 1, 2, 4, or 8, and may be selected by UE #1.

In some embodiments of the present disclosure, for a unicast sidelink transmission from UE #2 to UE #1, for a PSSCH (denoted as PSSCH #B2) scheduled by an SCI format (denoted as SCI #B2), an indicator (denoted as indicator #B) may be included in SCI #B2 for indicating how to adjust the CWS for UE #1 to perform a channel access procedure for transmitting a PSFCH (denoted as PSFCH #B2) carrying HARQ-ACK feedback for the scheduled PSSCH (i.e., PSSCH #B2). Indicator #B may be determined based on whether a previous PSFCH transmitted from UE #1 to UE #2 which carries HARQ-ACK feedback for a previous PSSCH is correctly received by UE #2 or not. UE #1 may determine, based on indicator #B, the CWS (denotes as CW_{p,#B2}, where p is the corresponding CAPC value for the sidelink transmission) to perform a channel access procedure (denoted as LBT #B2 which may be a Type-1 channel access procedure) for transmitting PSFCH #B2. The CAPC value p can also be referred to as the CAPC value associated with LBT #B2.

For example, in some embodiments of the present disclosure, indicator #B may indicate whether at least one of previous PSFCHs transmitted by UE #1 to UE #2 in the latest channel occupancy is correctly received by UE #2 or not. For example, before PSSCH #B2 (or SCI #B2), UE #1 may have transmitted one or more PSFCHs (i.e., the above-mentioned PSFCHs) to UE #2 in the latest channel occupancy. Indicator #B may indicate whether at least one of the one or more PSFCHs is correctly received by UE #2 or not.

In some embodiments, indicator #B may include at least one bit (e.g., 1 bit).

For example, bit “0” may indicate that at least one of the previous PSFCH transmissions transmitted by UE #1 to UE #2 in the latest channel occupancy is correctly received by UE #2 while bit “1” may indicate that none of the previous PSFCH transmissions transmitted by UE #1 to UE #2 in the latest channel occupancy is correctly received by UE #2; or vice versa.

When UE #2 transmits SCI #B2 and PSSCH #B2, in the case that UE #2 has correctly received at least one of the previous PSFCH transmissions transmitted by UE #1 to UE #2 in the latest channel occupancy. UE #2 may set indicator #B to indicate that at least one of the previous PSFCH transmissions is correctly received by UE #2. In response to receiving such indicator, the value of CW_{p,#B2} may be set (or reset) by UE #1 to the minimum allowed CWS value (e.g., CW_{p,min}) for the CAPC value p (where p is the corresponding CAPC value for the sidelink transmission or LBT #B2). UE #1 may then use CW_{p,#B2} for performing LBT #B2 for transmitting PSFCH #B2 and may transmit PSFCH #B2 in response to a successful channel access procedure.

When UE #2 transmits SCI #B2 and PSSCH #B2, in the case that UE #2 has not correctly received any of the previous PSFCH transmissions transmitted by UE #1 to UE #2 in the latest channel occupancy, UE #2 may set indicator #B to indicate that none of the previous PSFCH transmissions is correctly received by UE #2. In response to receiving such indicator, the value of CW_{p,#B2} may be increased to the next allowed higher CWS value.

For example, it is assumed that UE #2 transmits a PSCCH (denoted as PSCCH #B1) and a PSSCH (denoted as PSSCH #B1) scheduled by PSCCH #B1 in the latest channel occupancy. UE #1 transmits a PSFCH (denoted as PSFCH #B1) carrying HARQ-ACK feedback corresponding to PSSCH #B1, and PSFCH #B1 is one of the previous PSFCH transmissions transmitted by UE #1 to UE #2 in the latest channel occupancy. UE #1 may use a CWS to perform a channel access procedure (denoted as LBT #B1 which may be a Type-1 channel access procedure) for transmitting PSFCH #B1. The CWS used for LBT #B1 can be denoted as CW_{p,#B1}, where p is the corresponding CAPC value for the sidelink transmission. The CAPC value p can also be referred to as the CAPC value associated with LBT #B1 or LBT #B2.

In response to receiving indicator #B indicating that none of the previous PSFCH transmissions is correctly received by UE #2, the value of CW_{p,#B2} may be increased to the next allowed higher CWS value. For example, CW_{p,#B2} is set to the next allowed higher value compared with CW_{p,#B1} among the allowed CWS values for the CAPC value p. UE #1 may then use CW_{p,#B2} for performing LBT #B2 for transmitting PSFCH #B2 and may transmit PSFCH #B2 in response to a successful channel access procedure.

In some embodiments of the present disclosure, when UE #1 transmits a plurality of PSFCHs (e.g., including PSFCH #B1) in the latest channel occupancy to a plurality of UEs (for example, a plurality of Tx UEs including UE #2), from the perspective of UE #1, when at least one of the plurality of UEs uses indicator #B to indicate to UE #1 that at least one of the previous PSFCH transmissions (e.g., the plurality of PSFCHs) transmitted by UE #1 to UE #2 in the latest channel occupancy is correctly received by UE #2, UE #1 may set or reset the CWS to the minimum CWS (e.g., CW_{p,min}) to perform a channel access procedure (e.g., LBT #B2) for transmitting a PSFCH (e.g., PSFCH #B2).

For example, in some embodiments of the present disclosure, indicator #B may indicate a CWS reset or a CWS increase, that is, whether the CWS for UE #1 to perform a channel access procedure for transmitting a PSFCH (e.g., PSFCH #B2) corresponding to the scheduled PSSCH (e.g., PSSCH #B2) is reset (or set) to the minimum allowed CWS or increased to the next allowed higher value.

In some embodiments, indicator #B may include at least one bit (e.g., 1 bit). For example, bit “0” may indicate a CWS reset while bit “1” may indicate a CWS increase; or vice versa.

For example, in some embodiments of the present disclosure, for the sidelink transmission with the CAPC value p, when UE #2 transmits a PSCCH (denoted as PSCCH #B1′) and a PSSCH (denoted as PSSCH #B1′) scheduled by PSCCH #B1′, UE #2 may set indicator #B in the SCI format carried by PSCCH #B1′ to indicate to UE #1 to use the minimum CWS to perform a channel access procedure (denoted as LBT #B1′ which may be a Type-1 channel access procedure) for transmitting a PSFCH (denoted as PSFCH #B1′) carrying HARQ-ACK feedback corresponding to PSSCH #B1′. That is, indicator #B in the SCI format carried by PSCCH #B1′ indicates a CWS reset. UE #1 may determine the CWS (denotes as CW_{p,#B1′}) to perform LBT #B1′ based on the SCI format. For example, based on indicator #B, UE #1 may set CW_{p,#B1′} to the minimum allowed CWS value (e.g., CW_{p,min}) for the CAPC value p (i.e., CW_{p,#B1′}=CW_{p,min}). The CAPC value p can also be referred to as the CAPC value associated with LBT #B1′. UE #1 may transmit PSFCH #B1′ to UE #2 in response to a successful channel access procedure using CW_{p,#B1′}.

In the case that UE #2 correctly receives PSFCH #B1′ and when UE #2 further transmits SCI #B2 and PSSCH #B2 to UE #1, UE #2 may set indicator #B in SCI #B2 to indicate a CWS reset. That is, UE #2 may indicate UE #1 to use CW_{p,min} to perform LBT #B2 for transmitting PSFCH #B2 carrying HARQ-ACK feedback corresponding to PSSCH #B2, i.e., CW_{p,#B2}=CW_{p,min}. Based on indicator #B in SCI #B2, UE #1 may set CW_{p,#B2} to CW_{p,min}. UE #1 may transmit PSFCH #B2 to UE #2 in response to a successful channel access procedure using CW_{p,#B2}.

In the case that UE #2 does not correctly receive PSFCH #B1′, and when UE #2 further transmits SCI #B2 and PSSCH #B2 to UE #1, UE #2 may set indicator #B in SCI #B2 to indicate a CWS increase. That is, UE #2 may indicate UE #1 to increase the CWS to the next allowed higher CWS value to perform LBT #B2 for transmitting PSFCH #B2. Based on indicator #B in SCI #B2, UE #1 may set CW_{p,#B2} to the next allowed higher value compared with CW_{p,#B1′}, among the allowed CWS values for the CAPC value p. UE #1 may transmit PSFCH #B2 to UE #2 in response to a successful channel access procedure using CW_{p,#B2}.

For the sidelink transmission with the CAPC value p, in the case that UE #2 further transmits an SCI format (denoted as SCI #B3) and scheduled PSSCH (denoted as PSSCH #B3) to UE #1, similar to indicator #B in SCI #B2, UE #2 may set indicator #B in SCI #B3 based on whether UE #2 correctly receives PSFCH #B2 or not. UE #1 may then determine, based on indicator #B in SCI #B3, how to adjust the CWS for performing a channel access procedure for transmitting the PSFCH carrying HARQ-ACK feedback for PSSCH #B3.

For the perspective of UE #1, whether to reset the CWS to the minimum value or to increase the CWS to the next allowed higher value is fully dependent on the indication from UE #2. From the perspective of UE #2, UE #2 may determine the indication based on whether a previous PSFCH (e.g., PSFCH #B1′) is correctly received by UE #2 or not.

In some embodiments of the present disclosure, indicator #B may include more than one bit. For example, indicator #B may include two bits. For example, bit “00” may indicate a CWS reset, bit “01” may indicate a CWS increase, and bit “10” indicates a CWS unchanged (e.g., CW_{p,#B2}=CW_{p,#B1′}).

In some embodiments of the present disclosure, for a groupcast sidelink transmission from UE #2 to a group of UEs including UE #1, for a PSSCH (denoted as PSSCH #C2) scheduled by an SCI format (denoted as SCI #C2), an indicator (denoted as indicator #C) may be included in SCI #C2 for indicating how to adjust the CWS to perform a channel access procedure for transmitting a PSFCH (denoted as PSFCH #C2) carrying HARQ-ACK feedback for the scheduled PSSCH (i.e., PSSCH #C2). Indicator #C may be determined based on whether a previous PSFCH transmitted from the group of UEs to UE #2 which carries HARQ-ACK feedback for a previous PSSCH is correctly received by UE #2 or not. A UE (e.g., UE #1) in the group of UEs may determine, based on indicator #C, the CWS (denotes as CW_{p,#C2}, where p is the corresponding CAPC value for the sidelink transmission) to perform a channel access procedure (denoted as LBT #C2 which may be a Type-1 channel access procedure) for transmitting PSFCH #C2. The CAPC value p can also be referred to as the CAPC value associated with LBT #C2.

For example, in some embodiments of the present disclosure, indicator #C may indicate a CWS reset or a CWS increase, that is, whether the CWS for a UE (e.g., UE #1) in the group of UEs to perform a channel access procedure for transmitting a PSFCH (e.g., PSFCH #C2) corresponding to the scheduled PSSCH (e.g., PSSCH #C2) is reset (or set) to the minimum allowed CWS or increased to the next allowed higher value.

In some embodiments, indicator #C may include at least one bit (e.g., 1 bit). For example, bit “0” may indicate a CWS reset while bit “1” may indicate a CWS increase; or vice versa.

For example, for the sidelink transmission with the CAPC value p, when UE #2 transmits a PSCCH (denoted as PSCCH #C1) and a PSSCH (denoted as PSSCH #C1) scheduled by PSCCH #C1 to the group of UEs, UE #2 may set indicator #C in the SCI format carried by PSCCH #C1 to indicate to each UE in the group of UEs including UE #1 to use the minimum CWS to perform a channel access procedure (denoted as LBT #C1 which may be a Type-1 channel access procedure) for transmitting a PSFCH (denoted as PSFCH #C1) carrying HARQ-ACK feedback corresponding to PSSCH #C1. That is, indicator #C in the SCI format carried by PSCCH #C1 indicates a CWS reset. Each UE (e.g., UE #1) in the group of UEs may determine the CWS (denotes as CW_{p,#C1}) to perform LBT #C1 based on the SCI format. For example, based on indicator #C. UE #1 may set CW_{p,#C1} to the minimum allowed CWS value (e.g., CW_{p,min}) for the CAPC value p (i.e., CW_{p,#C1}=CW_{p,min}). The CAPC value p can also be referred to as the CAPC value associated with LBT #C1. Each UE (e.g., UE #1) in the group of UEs may perform a channel access procedure (e.g., LBT #C1) before transmitting the correspond PSFCH (e.g., PSFCH #C1) using the determined CWS (e.g., CW_{p,#C1}). For example, UE #1 may transmit PSFCH #C1 to UE #2 in response to a successful channel access procedure.

In some embodiments of the present disclosure, in the case that UE #2 correctly receives PSFCH #C1 from at least one UE (e.g., UE #1) of the group of UEs and when UE #2 further transmits SCI #C2 and PSSCH #C2 to the group of UEs including UE #1, UE #2 may set indicator #C in SCI #C2 to indicate a CWS reset. That is. UE #2 may indicate each UE in the group of UEs to use CW_{p,min} to perform a channel access procedure for transmitting PSFCH #C2 carrying HARQ-ACK feedback corresponding to PSSCH #C2, i.e., CW_{p,#C2}=CW_{p,min}. Based on indicator #C in SCI #C2, UEs (e.g., UE #1) in the group of UEs may set CW_{p,#C2} to CW_{p,min}. For example, UE #1 may transmit PSFCH #C2 to UE #2 in response to a successful channel access procedure performed by UE #1 using CW_{p,#C2}.

In the case that UE #2 does not correctly receive PSFCH #C1 from any UE in the group of UEs, and when UE #2 further transmits SCI #C2 and PSSCH #C2 to the group of UEs including UE #1, UE #2 may set indicator #C in SCI #C2 to indicate a CWS increase. That is, UE #2 may indicate each UE in the group of UEs to increase the CWS to the next allowed higher CWS value to perform LBT #C2 for transmitting PSFCH #C2. Based on indicator #C in SCI #C2, UEs (e.g., UE #1) in the group of UEs may set CW_{p,#C2} to the next allowed higher value compared with CW_{p,#C1} among the allowed CWS values for the CAPC value p. For example, UE #1 may transmit PSFCH #C2 to UE #2 in response to a successful channel access procedure performed by UE #1 using CW_{p,#C1}.

In some embodiments of the present disclosure, in the case that UE #2 correctly receives PSFCH #C1 from at least a ratio of UEs in the group of UEs and when UE #2 further transmits SCI #C2 and PSSCH #C2 to the group of UEs including UE #1, UE #2 may set indicator #C in SCI #C2 to indicate a CWS reset. That is, UE #2 may indicate each UE in the group of UEs to use CW_{p,min} to perform a channel access procedure for transmitting PSFCH #C2 carrying HARQ-ACK feedback corresponding to PSSCH #C2, i.e., CW_{p,#C1}=CW_{p,min}. Based on indicator #C in SCI #C2, UEs (e.g., UE #1) in the group of UEs may set CW_{p,#C2} to CW_{p,min}. For example, UE #1 may transmit PSFCH #C2 to UE #2 in response to a successful channel access procedure performed by UE #1 using CW_{p,#C2}.

In the case that UE #2 receives PSFCH #C1 from a number of UEs less than the ratio of UEs in the group of UEs, and when UE #2 further transmits SCI #C2 and PSSCH #C2 to the group of UEs including UE #1, UE #2 may set indicator #C in SCI #C2 to indicate a CWS increase. That is, UE #2 may indicate each UE in the group of UEs to increase the CWS to the next allowed higher CWS value to perform LBT #C2 for transmitting PSFCH #C2. Based on indicator #C in SCI #C2, UEs (e.g., UE #1) in the group of UEs may set CW_{p,#C2} to the next allowed higher value compared with CW_{p,#C1} among the allowed CWS values for the CAPC value p. For example, UE #1 may transmit PSFCH #C2 to UE #2 in response to a successful channel access procedure performed by UE #1 using CW_{p,#C2}.

In some embodiments, the ratio of UEs may be preconfigured, configured by, for example, RRC signaling, or predefined, for example, in a standard(s). In some embodiments, the ratio may be equal to 20% or 30%. For example, assuming the group of UEs includes 100 UEs, in the case that UE #2 correctly receives PSFCH #C1 from 20 or more than 20 UEs in the group of UEs, indicator #C in SCI #C2 may be set to indicate a CWS reset; otherwise, in the case that UE #2 correctly receives PSFCH #C1 from less than 20 UEs in the group of UEs (e.g., in the worst case, UE #2 does not correctly receive PSFCH #C1 from any UE in the group of UEs), indicator #C in SCI #C2 may be set to indicate a CWS increase. In some examples, the ratio can beset to 100%.

In some embodiments, for the sidelink transmission with the CAPC value p, in the case that UE #2 further transmits an SCI format (denoted as SCI #C3) and the scheduled PSSCH (denoted as PSSCH #C3) to UE #1, similar to indicator #C in SCI #C2, UE #2 may set indicator #C in SCI #C3 to indicate a CWS reset or increase based on whether UE #2 correctly receives PSFCH #C2 or not. UE #1 may then determine, based on indicator #C in SCI #C3, how to adjust the CWS for performing a channel access procedure for transmitting the PSFCH carrying HARQ-ACK feedback for PSSCH #C3.

From the perspective of UE #1 (either in a unicast or a groupcast scenario), whether to reset the CWS to the minimum value or to increase the CWS to the next allowed higher value is fully dependent on the indication from UE #2. From the perspective of UE #2, UE #2 may determine the indication based on whether a previous PSFCH (e.g., PSFCH #C1) is correctly received by UE #2 or not.

In some embodiments of the present disclosure, indicator #C may include more than one bit. For example, indicator #C may include two bits. For example, bit “00” may indicate a CWS reset, bit “01” may indicate a CWS increase, and bit “10” indicates a CWS unchanged (e.g., CW_{p,#C2}=CW_{p,#C1}).

In some embodiments of the present disclosure, the CWS for UE #1 to perform a channel access procedure for transmitting a PSFCH to UE #2 may be determined or adjusted based on a default setting.

For example, for a unicast sidelink transmission from UE #2 to UE #1 or a groupcast sidelink transmission from UE #2 to a group of UEs including UE #1, assuming that UE #2 transmits a PSSCH (denoted as PSSCH #D1) and UE #1 needs to perform a channel access procedure (denoted as LBT #D1 which may be a Type-1 channel access procedure) for transmitting a PSFCH (denoted as PSFCH #D1) carrying HARQ-ACK feedback corresponding to PSSCH #D1, UE #1 may determine the CWS used for performing LBT #D1 based on the default setting. UE #1 may then perform LBT #D1 using the determined CWS, and transmit PSFCH #D1 to UE #2 in response to LBT #D1 being successful.

In some embodiments, the default setting may be a default CWS preconfigured, configured by, for example, RRC signaling, or predefined, for example, in a standard(s). In some embodiments, the default setting may be consistently used by UE #1 for performing channel access procedures (e.g., Type-1 channel access procedures) for PSFCH transmissions. In some embodiments, the default setting may be consistently used in in one channel occupancy. In some embodiments, the default setting may be the minimum CWS of allowed CWSs of one CAPC value (e.g., a reference CAPC value) of allowed CAPC values; the maximum of the allowed CWSs of the one CAPC value; or an average CWS among all of the allowed CWSs for the one CAPC value.

For example, referring to Table 1, allowed CAPC values may include CAPC 1 to CAPC 4. The reference CAPC value can be any one of the allowed CAPC values. For example, the default setting may be the minimum allowed CWS of CAPC 1 (i.e., the default CWS is 3); the maximum allowed CWS of CAPC 1 (i.e., the default CWS is 7); or an average CWS among all of the allowed CWSs for CAPC 1 (i.e., the default CWS is 5). For example, the default setting may be the minimum allowed CWS of CAPC 2 (i.e., the default CWS is 7); the maximum allowed CWS of CAPC 2 (i.e., the default CWS is 15); or an average CWS among all of the allowed CWSs for CAPC 2 (i.e., the default CWS is 11).

The above method for determining the CWS used for performing a channel access procedure for transmitting a PSFCH based on a default setting is also applicable to sidelink synchronization signal block (SSB) transmissions. For example, when a UE (e.g., a Tx UE such as UE #2) intends to transmit a sidelink SSB, the UE may use the default setting (e.g., a default CWS) for performing a channel access procedure (e.g., a Type-1 channel access procedure) for transmitting the sidelink SSB.

In some embodiments of the present disclosure, the CWS for UE #1 to perform a channel access procedure for transmitting a PSFCH to UE #2 may be determined or adjusted based on an occupancy state of the sidelink channel.

For example, for a unicast sidelink transmission from UE #2 to UE #1 or a groupcast sidelink transmission from UE #2 to a group of UEs including UE #1, assuming that UE #2 transmits a PSSCH (denoted as PSSCH #E) and UE #1 needs to perform a channel access procedure (denoted as LBT #E which may be a Type-1 channel access procedure) on the sidelink channel for transmitting a PSFCH (denoted as PSFCH #E) carrying HARQ-ACK feedback corresponding to PSSCH #E, UE #1 may determine the CWS (denotes as CW_{p,#E}, where p is the corresponding CAPC value for the sidelink transmission) used for performing LBT #E based on an occupancy state of the sidelink channel. UE #1 may then perform LBT #E using the determined CWS, and transmit PSFCH #E to UE #2 in response to LBT #E being successful. The CAPC value p can also be referred to as the CAPC value associated with LBT #E.

In some embodiments, the occupancy state of the channel may be determined based on a channel occupancy ratio (CR) measurement or a channel busy ratio (CBR) measurement on the channel. The sidelink CR or CBR represents the ratio of sidelink channels being occupied.

For example, UE #1 may perform a CR measurement or a CBR measurement on the channel. In the case that the result of the CR measurement or the CBR measurement is less than or equal to a threshold for channel occupancy, UE #1 may set or reset CW_{p,#E} to the minimum allowed CWS (e.g., CW_{p,min}) to perform LBT #E for transmitting PSFCH #E. In the case that the result of the CR measurement or the CBR measurement is greater than the threshold for channel occupancy, UE #1 may increase the CWS to the next allowed higher CWS value. For example, similarly as describe before, UE #1 may increase a previously used CWS value to the next allowed CWS value among allowed CWS values for the CAPC value p and set the value of CW_{p,#E} to the increased value. For example, the previously CWS value refers to the CWS used for performing a channel access procedure (e.g., a Type-1 channel access procedure) for transmitting a PSFCH, which carries HARQ-ACK feedback corresponding to a PSSCH previously transmitted from UE #2 to UE #1 or the group of UEs including UE #1 for the sidelink transmission with the CAPC value p.

In some embodiments, the threshold for channel occupancy (e.g., a CR threshold or a CBR threshold) may be preconfigured, configured by, for example, RRC signaling, or predefined, for example, in a standard(s).

The above method for determining the CWS used for performing a channel access procedure for transmitting a PSFCH based on the channel occupancy state is also applicable to SSB transmissions. For example, when a UE (e.g., a Tx UE such as UE #2) intends to transmit a sidelink SSB, the UE may determine the CWS used for performing a channel access procedure (e.g., a Type-1 channel access procedure) for transmitting the sidelink SSB based on the channel occupancy state.

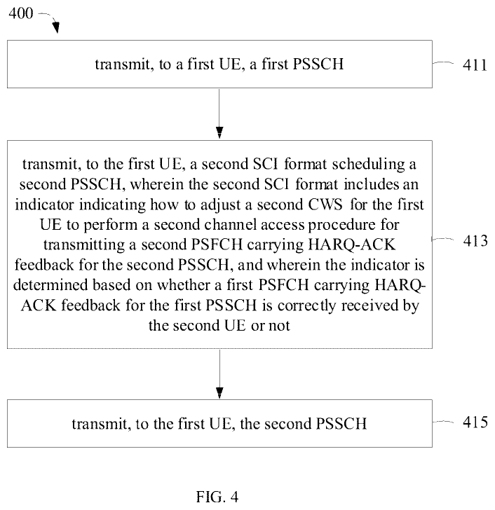

FIG. 3 illustrates a flow chart of exemplary procedure 300 for sidelink communications in accordance with some embodiments of the present disclosure. Details described in all of the foregoing embodiments of the present disclosure are applicable for the embodiments shown in FIG. 3. In some examples, the procedure may be performed by a UE, for example, UE 110 in FIG. 1.

Referring to FIG. 3, in operation 311, a first UE may receive, from a second UE, a first PSSCH. In some embodiments of the present disclosure, the first UE and second UE may respectively function as UE #1 and UE #2 as described above.

In operation 313, the first UE may transmit, to the second UE, a first PSFCH carrying HARQ-ACK feedback for the first PSSCH. In operation 315, the first UE may receive, from the second UE, a second PSSCH.

In operation 317, the first UE may determine, based on whether the first PSFCH is correctly received by the second UE or not, a second CWS for the first UE to perform a second channel access procedure for transmitting a second PSFCH carrying HARQ-ACK feedback for the second PSSCH. In operation 319, the first UE may perform the second channel access procedure using the second CWS.

In some embodiments of the present disclosure, the first UE may further: receive, from the second UE, a first SCI format scheduling the first PSSCH, wherein the first SC format indicates an NDI, a HARQ process number, a source ID and a destination ID associated with the first PSSCH; and receive, from the second UE, a second SCI format scheduling the second PSSCH, wherein the second SCI format indicates an NDI, a HARQ process number, a source ID and a destination ID associated with the second PSSCH. Determining the second CWS may include determining the second CWS based on the NDI, the HARQ process number, the source ID and the destination ID associated with the first PSSCH and the NDI, the HARQ process number, the source ID and the destination ID associated with the second PSSCH.

In some embodiments of the present disclosure, the first UE may further determine a first CWS for the first UE to perform a first channel access procedure for transmitting the first PSFCH. Determining the second CWS may include: in the case that the HARQ process number, the source ID and the destination ID associated with the first PSSCH are respectively the same as the HARQ process number, the source ID and the destination ID associated with the second PSSCH, determining a value of the second CWS by one of the following: setting the value of the second CWS to a minimum allowed CWS value for a CAPC value associated with the second channel access procedure, in the case that (a) the first PSFCH carries an ACK for the first PSSCH and the NDI associated with the second PSSCH is toggled compared with the NDI associated with the first PSSCH or in the case that (b) the first PSFCH carries a NACK for the first PSSCH and the NDI associated with the second PSSCH is non-toggled compared with the NDI associated with the first PSSCH; increasing a value of the first CWS to a next allowed CWS value among allowed CWS values for the CAPC value and setting the value of the second CWS to the increased value, in the case that (c) the first PSFCH carries an ACK for the first PSSCH and the NDI associated with the second PSSCH is non-toggled compared with the NDI associated with the first PSSCH, or in the case of (b); or setting the value of the second CWS to the value of the first CWS in the case of (b) or in all cases other than (a)-(c).

In some embodiments of the present disclosure, the first UE may further determine a first CWS for the first UE to perform a first channel access procedure for transmitting the first PSFCH. Determining the second CWS may include in the case that the HARQ process number, the source ID and the destination ID associated with the first PSSCH are respectively the same as the HARQ process number, the source ID and the destination ID associated with the second PSSCH, determining a value of the second CWS by one of the following: increasing a value of the first CWS to a next allowed CWS value among allowed CWS values for a CAPC value associated with the second channel access procedure and setting the value of the second CWS to the increased value in the case that the value of the first CWS is consecutively used by a number of times (e.g., K times) for performing a channel access procedure; or setting the value of the second CWS to a minimum allowed CWS value for the CAPC value in the case that the value of the first CWS is a maximum allowed CWS value among the allowed CWS values for the CAPC value and is consecutively used the number of times (e.g., K times) for performing a channel access procedure.

In some embodiments of the present disclosure, the first UE may further receive, from the second UE, a second SCI format scheduling the second PSSCH, wherein the second SCI format includes an indicator indicating whether at least one of previous PSFCHs including the first PSFCH transmitted by the first UE to the second UE in a latest channel occupancy is correctly received by the second UE or not. Determining the second CWS may include determining the second CWS based on the indicator in the second SCI format. For example, the indicator may be indicator #B as described above.

For example, in some embodiments of the present disclosure, the first UE may further determine a first CWS for the first UE to perform a first channel access procedure for transmitting the first PSFCH. Determining the second CWS may include: setting a value of the second CWS to a minimum allowed CWS value for a CAPC value associated with the second channel access procedure in the case that the indicator indicates that at least one of the previous PSFCHs is correctly received by the second UE; or increasing a value of the first CWS to a next allowed CWS value among allowed CWS values for the CAPC value and setting the value of the second CWS to the increased value in the case that the indicator indicates that none of the previous PSFCHs is correctly received by the second UE.

In some embodiments of the present disclosure, the first UE may further receive, from the second UE, a second SCI format scheduling the second PSSCH, wherein the second SCI format includes an indicator indicating how to adjust the second CWS. Determining the second CWS may include determining the second CWS based on the indicator in the second SCI format. For example, the indicator may be one of indicator #B and indicator #C as described above.

For example, in some embodiments of the present disclosure, the first UE may further determine a first CWS for the first UE to perform a first channel access procedure for transmitting the first PSFCH. Determining the second CWS may include: setting a value of the second CWS to a minimum allowed CWS value for a CAPC value associated with the second channel access procedure in the case that the indicator indicates a CWS reset; or increasing a value of the first CWS to a next allowed CWS value among allowed CWS values for the CAPC value and setting the value of the second CWS to the increased value in the case that the indicator indicates to a CWS increase.

It should be appreciated by persons skilled in the art that the sequence of the operations in exemplary procedure 300 may be changed and some of the operations in exemplary procedure 300 may be eliminated or modified, without departing from the spirit and scope of the disclosure.

FIG. 4 illustrates a flow chart of exemplary procedure 400 for sidelink communications in accordance with some embodiments of the present disclosure. Details described in all of the foregoing embodiments of the present disclosure are applicable for the embodiments shown in FIG. 4. In some examples, the procedure may be performed by a UE, for example, UE 110 in FIG. 1.

Referring to FIG. 4, in operation 411, a second UE may transmit, to a first UE, a first PSSCH. In some embodiments of the present disclosure, the first UE and second UE may respectively function as UE #1 and UE #2 as described above.

In operation 413, the second UE may transmit, to the first UE, a second SCI format scheduling a second PSSCH, wherein the second SCI format includes an indicator indicating how to adjust a second CWS for the first UE to perform a second channel access procedure for transmitting a second PSFCH carrying HARQ-ACK feedback for the second PSSCH, and wherein the indicator is determined based on whether a first PSFCH carrying HARQ-ACK feedback for the first PSSCH is correctly received by the second UE or not. For example, the indicator may be one of indicator #B and indicator #C as described above.

In some embodiments of the present disclosure, the indicator indicates whether at least one of previous PSFCHs including the first PSFCH transmitted by the first UE to the second UE in a latest channel occupancy is correctly received by the second UE or not.

In some embodiments of the present disclosure, the indicator indicates a CWS reset in the case that the second UE correctly receives the first PSFCH from the first UE; or the indicator indicates a CWS increase in the case that the second UE does not correctly receive the first PSFCH from the first UE.

In some embodiments of the present disclosure, the first PSSCH and the second PSSCH are transmitted to a group of UEs including the first UE. The indicator indicates a CWS reset to each UE in the group of UEs in the case that the second UE correctly receives a PSFCH carrying HARQ-ACK feedback for the first PSSCH from at least one UE in the group of UEs, or the indicator indicates a CWS increase to each UE in the group of UEs in the case that the second UE does not correctly receive a PSFCH carrying HARQ-ACK feedback for the first PSSCH from any UE in the group of UEs.

In some embodiments of the present disclosure, the first PSSCH and the second PSSCH are transmitted to a group of UEs including the first UE. The indicator indicates a CWS reset to each UE in the group of UEs in the case that the second UE correctly receives a PSFCH carrying HARQ-ACK feedback for the first PSSCH from at least a ratio of UEs in the group of UEs, or the indicator indicates a CWS increase to each UE in the group of UEs in the case that the second UE correctly receive a PSFCH carrying HARQ-ACK feedback for the first PSSCH from a number of UEs less than the ratio of UEs in the group of UEs.

In some embodiments of the present disclosure, in the case that the indicator indicates that at least one of the previous PSFCHs is correctly received by the second UE or a CWS reset, a value of the second CWS is set to a minimum allowed CWS value for a CAPC value associated with the second channel access procedure. In some embodiments of the present disclosure, in the case that the indicator indicates that none of the previous PSFCHs is correctly received by the second UE or a CWS increase, the value of the second CWS is set by increasing a value of a first CWS for the first UE to perform a first channel access procedure for transmitting the first PSFCH to a next allowed CWS value among allowed CWS values for the CAPC value.

In some embodiments of the present disclosure, the second UE may further transmit, to the first UE, a first SC format scheduling the first PSSCH, wherein the first SCI format indicates that a first channel access procedure for transmitting the first PSFCH uses a minimum allowed CWS value for a CAPC value associated with the first channel access procedure.

In operation 415, the second UE may transmit, to the first UE, the second PSSCH.

It should be appreciated by persons skilled in the art that the sequence of the operations in exemplary procedure 400 may be changed and some of the operations in exemplary procedure 400 may be eliminated or modified, without departing from the spirit and scope of the disclosure.

FIG. 5 illustrates a flow chart of exemplary procedure 500 for sidelink communications in accordance with some embodiments of the present disclosure. Details described in all of the foregoing embodiments of the present disclosure are applicable for the embodiments shown in FIG. 5. In some examples, the procedure may be performed by a UE, for example, UE 110 in FIG. 1.

Referring to FIG. 5, in operation 511, a first UE may receive, from a second UE, a PSSCH. In some embodiments of the present disclosure, the first UE and second UE may respectively function as UE #1 and UE #2 as described above.

In operation 513, the first UE may determine, based on a default setting or an occupancy state of a channel, a CWS for the first UE to perform a channel access procedure for transmitting a PSFCH carrying HARQ-ACK feedback for the PSSCH.

In operation 515, the first UE may perform the channel access procedure on the channel using the CWS. In operation 517, the first UE may transmit, to the second UE, the PSFCH in response to the channel access procedure being successful.

In some embodiments of the present disclosure, the CWS is consistently used by the first UE for performing channel access procedures for PSFCH transmissions.

In some embodiments of the present disclosure, the default setting is: a minimum CWS of allowed CWSs of one CAPC value of allowed CAPC values; a maximum CWS of the allowed CWSs of the one CAPC value; or an average CWS among all of the allowed CWSs for the one CAPC value.

In some embodiments of the present disclosure, the first UE may further perform a CR measurement or a CBR measurement on the channel. Determining the CWS based on the occupancy state of the channel may include: setting a value of the CWS to a minimum allowed CWS value for a CAPC value associated with the channel access procedure in the case that a result of the CR measurement or the CBR measurement is less than or equal to a threshold for channel occupancy; or increasing a previously used CWS value to a next allowed CWS value among allowed CWS values for the CAPC value and setting the value of the CWS to the increased value in the case that the result of the CR measurement or the CBR measurement is greater than the threshold for channel occupancy.

It should be appreciated by persons skilled in the art that the sequence of the operations in exemplary procedure 500 may be changed and some of the operations in exemplary procedure 500 may be eliminated or modified, without departing from the spirit and scope of the disclosure.

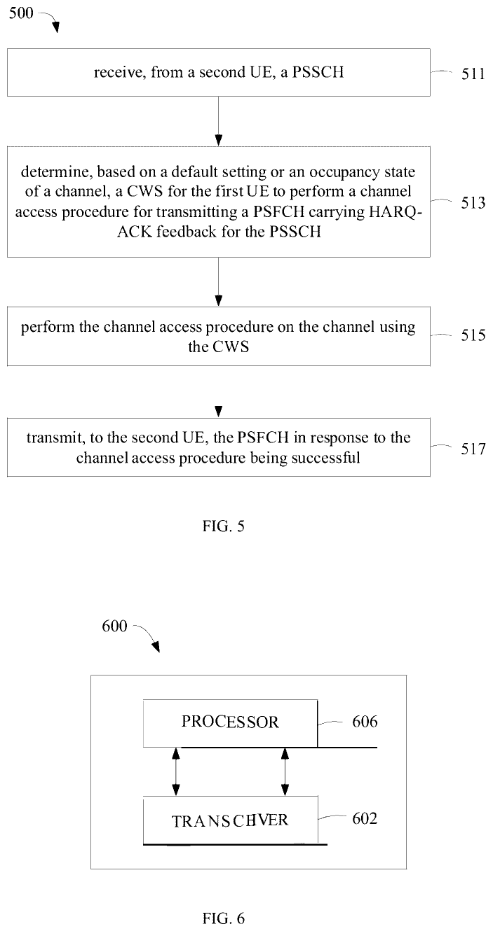

FIG. 6 illustrates a block diagram of an exemplary apparatus 600 according to some embodiments of the present disclosure. As shown in FIG. 6, the apparatus 600 may include at least one processor 606 and at least one transceiver 602 coupled to the processor 606. The apparatus 600 may be a UE.

Although in this figure, elements such as the at least one transceiver 602 and processor 606 are described in the singular, the plural is contemplated unless a limitation to the singular is explicitly stated. In some embodiments of the present application, the transceiver 602 may be divided into two devices, such as a receiving circuitry and a transmitting circuitry. In some embodiments of the present application, the apparatus 600 may further include an input device, a memory, and/or other components.

In some embodiments of the present application, the apparatus 600 may be a UE. The transceiver 602 and the processor 606 may interact with each other so as to perform the operations with respect to the UEs described in FIGS. 1-5.

In some embodiments of the present application, the apparatus 600 may further include at least one non-transitory computer-readable medium. For example, in some embodiments of the present disclosure, the non-transitory computer-readable medium may have stored thereon computer-executable instructions to cause the processor 606 to implement the methods with respect to the UEs as described above. For example, the computer-executable instructions, when executed, cause the processor 606 interacting with transceiver 602 to perform the operations with respect to the UEs described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an.” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first user equipment (UE) for wireless communication, comprising:
at least one memory; and
at least one processor coupled with the at least one memory and configured to cause the first UE to:
receive, from a second UE, a first physical sidelink shared channel (PSSCH);
transmit, to the second UE, a first physical sidelink feedback channel (PSFCH) carrying hybrid automatic repeat request acknowledgement (HARQ-ACK) feedback for the first PSSCH;
receive, from the second UE, a second PSSCH;
determine, based on whether the first PSFCH is correctly received by the second UE or not, a second contention window size (CWS) for the first UE to perform a second channel access procedure for transmitting a second PSFCH carrying HARQ-ACK feedback for the second PSSCH; and
perform the second channel access procedure using the second CWS.

2. The first UE of claim 1, wherein the at least one processor is further configured to cause the first UE to:
receive, from the second UE, a first sidelink control information (SCI) format scheduling the first PSSCH, wherein the first SCI format indicates a new data indicator (NDI), a HARQ process number, a source ID and a destination ID associated with the first PSSCH; and
receive, from the second UE, a second SCI format scheduling the second PSSCH, wherein the second SCI format indicates an NDI, a HARQ process number, a source ID and a destination ID associated with the second PSSCH;
wherein determining the second CWS comprises determining the second CWS based on the NDI, the HARQ process number, the source ID and the destination ID associated with the first PSSCH and the NDI, the HARQ process number, the source ID and the destination ID associated with the second PSSCH.

3. The first UE of claim 2, wherein the at least one processor is further configured to cause the first UE to determine a first CWS for the first UE to perform a first channel access procedure for transmitting the first PSFCH; and
wherein determining the second CWS comprises, when the HARQ process number, the source ID and the destination ID associated with the first PSSCH are the same as the HARQ process number, the source ID and the destination ID associated with the second PSSCH, respectively, determining a value of the second CWS by one of the following:
setting the value of the second CWS to a minimum allowed CWS value for a channel access priority class (CAPC) value associated with the second channel access procedure, when (a) the first PSFCH carries an acknowledgement (ACK) for the first PSSCH and the NDI associated with the second PSSCH is toggled compared with the NDI associated with the first PSSCH, or when (b) the first PSFCH carries a negative ACK (NACK) for the first PSSCH and the NDI associated with the second PSSCH is non-toggled compared with the NDI associated with the first PSSCH;
increasing a value of the first CWS to a next allowed CWS value among allowed CWS values for the CAPC value and setting the value of the second CWS to the increased value, when (c) the first PSFCH carries an ACK for the first PSSCH and the NDI associated with the second PSSCH is non-toggled compared with the NDI associated with the first PSSCH, or when (b); or
setting the value of the second CWS to the value of the first CWS in the case of (b) or in all cases other than (a)-(c).

4. The first UE of claim 2, wherein the at least one processor is further configured to cause the first UE to determine a first CWS for the first UE to perform a first channel access procedure for transmitting the first PSFCH; and
wherein determining the second CWS comprises, when the HARQ process number, the source ID and the destination ID associated with the first PSSCH are respectively the same as the HARQ process number, the source ID and the destination ID associated with the second PSSCH, determining a value of the second CWS by one of the following:
increasing a value of the first CWS to a next allowed CWS value among allowed CWS values for a channel access priority class (CAPC) value associated with the second channel access procedure and setting the value of the second CWS to the increased value when the value of the first CWS is consecutively used by a number of times for performing a channel access procedure; or
setting the value of the second CWS to a minimum allowed CWS value for the CAPC value when the value of the first CWS is a maximum allowed CWS value among the allowed CWS values for the CAPC value and is consecutively used the number of times for performing a channel access procedure.

5. The first UE of claim 1, wherein the at least processor is further configured to cause the first UE to:
receive, from the second UE, a second sidelink control information (SCI) format scheduling the second PSSCH, wherein the second SCI format includes an indicator indicating whether at least one of previous PSFCHs including the first PSFCH transmitted by the first UE to the second UE in a latest channel occupancy is correctly received by the second UE or not; and
wherein determining the second CWS comprises determining the second CWS based on the indicator in the second SCI format.

6. The first UE of claim 1, wherein the at least one processor is further configured to cause the first UE to:
receive, from the second UE, a second sidelink control information (SCI) format scheduling the second PSSCH, wherein the second SCI format includes an indicator indicating how to adjust the second CWS; and
wherein determining the second CWS comprises determining the second CWS based on the indicator in the second SCI format.

7. A second user equipment (UE) for wireless communication, comprising:
at least one memory; and
at least one processor coupled with the at least one memory and configured to cause the second UE to:
transmit, to a first UE, a first physical sidelink shared channel (PSSCH);
transmit, to the first UE, a second sidelink control information (SCI) format scheduling a second PSSCH, wherein the second SCI format includes an indicator indicating how to adjust a second contention window size (CWS) for the first UE to perform a second channel access procedure for transmitting a second physical sidelink feedback channel (PSFCH) carrying hybrid automatic repeat request acknowledgement (HARQ-ACK) feedback for the second PSSCH, and wherein the indicator is determined based on whether a first PSFCH carrying HARQ-ACK feedback for the first PSSCH is correctly received by the second UE or not; and
transmit, to the first UE, the second PSSCH.

8. The second UE of claim 7, wherein the indicator indicates whether at least one of previous PSFCHs including the first PSFCH transmitted by the first UE to the second UE in a latest channel occupancy is correctly received by the second UE or not.

9. The second UE of claim 7, wherein the indicator indicates a CWS reset when the second UE correctly receives the first PSFCH from the first UE; or wherein the indicator indicates a CWS increase when the second UE does not correctly receive the first PSFCH from the first UE.

10. The second UE of claim 7, wherein the first PSSCH and the second PSSCH are transmitted to a group of UEs including the first UE; and
wherein the indicator indicates a CWS reset to each UE in the group of UEs when the second UE correctly receives a PSFCH carrying HARQ-ACK feedback for the first PSSCH from at least one UE in the group of UEs, or the indicator indicates a CWS increase to each UE in the group of UEs when the second UE does not correctly receive a PSFCH carrying HARQ-ACK feedback for the first PSSCH from any UE in the group of UEs.

11. The second UE of claim 7, wherein the first PSSCH and the second PSSCH are transmitted to a group of UEs including the first UE; and
wherein the indicator indicates a CWS reset to each UE in the group of UEs when the second UE correctly receives a PSFCH carrying HARQ-ACK feedback for the first PSSCH from at least a ratio of UEs in the group of UEs, or wherein the indicator indicates a CWS increase to each UE in the group of UEs when the second UE correctly receive a PSFCH carrying HARQ-ACK feedback for the first PSSCH from a number of UEs less than the ratio of UEs in the group of UEs.

12. The second UE of claim 8, wherein, when the indicator indicates that at least one of the previous PSFCHs is correctly received by the second UE or a CWS reset, a value of the second CWS is set to a minimum allowed CWS value for a channel access priority class (CAPC) value associated with the second channel access procedure; or
wherein, when the indicator indicates that none of the previous PSFCHs is correctly received by the second UE or a CWS increase, the value of the second CWS is set by increasing a value of a first CWS for the first UE to perform a first channel access procedure for transmitting the first PSFCH to a next allowed CWS value among allowed CWS values for the CAPC value.

13. A first user equipment (UE) for wireless communication, comprising:
at least one memory; and
at least one processor coupled with the at least one memory and configured to cause the first UE to:
receive, from a second UE, a physical sidelink shared channel (PSSCH);
determine, based on a default setting or an occupancy state of a channel, a contention window size (CWS) for the first UE to perform a channel access procedure for transmitting a physical sidelink feedback channel (PSFCH) carrying hybrid automatic repeat request acknowledgement (HARQ-ACK) feedback for the PSSCH;
perform the channel access procedure on the channel using the CWS; and
transmit, to the second UE, the PSFCH in response to the channel access procedure being successful.

14. The first UE of claim 13, wherein the CWS is consistently used by the first UE for performing channel access procedures for PSFCH transmissions; and
wherein the default setting is:
a minimum CWS of allowed CWSs of one channel access priority class (CAPC) value of allowed CAPC values;
a maximum CWS of the allowed CWSs of the one CAPC value; or
an average CWS among all of the allowed CWSs for the one CAPC value.

15. The first UE of claim 13, wherein the at least processor is further configured to cause the first UE to perform a channel occupancy ratio (CR) measurement or a channel busy ratio (CBR) measurement on the channel; and
wherein determining the CWS based on the occupancy state of the channel comprises:
setting a value of the CWS to a minimum allowed CWS value for a channel access priority class (CAPC) value associated with the channel access procedure when a result of the CR measurement or the CBR measurement is less than or equal to a threshold for channel occupancy; or
increasing a previously used CWS value to a next allowed CWS value among allowed CWS values for the CAPC value and setting the value of the CWS to the increased value when the result of the CR measurement or the CBR measurement is greater than the threshold for channel occupancy.

16. A method performed by a first user equipment (UE), the method comprising:
receiving, from a second UE, a first physical sidelink shared channel (PSSCH);
transmitting, to the second UE, a first physical sidelink feedback channel (PSFCH) carrying hybrid automatic repeat request acknowledgement (HARQ-ACK) feedback for the first PSSCH;
receiving, from the second UE, a second PSSCH;
determining, based on whether the first PSFCH is correctly received by the second UE or not, a second contention window size (CWS) for the first UE to perform a second channel access procedure for transmitting a second PSFCH carrying HARQ-ACK feedback for the second PSSCH; and
performing the second channel access procedure using the second CWS.

17. The method of claim 16, further comprising:
receiving, from the second UE, a first sidelink control information (SCI) format scheduling the first PSSCH, wherein the first SCI format indicates a new data indicator (NDI), a HARQ process number, a source ID and a destination ID associated with the first PSSCH; and
receiving, from the second UE, a second SCI format scheduling the second PSSCH, wherein the second SCI format indicates an NDI, a HARQ process number, a source ID and a destination ID associated with the second PSSCH;
wherein determining the second CWS comprises determining the second CWS based on the NDI, the HARQ process number, the source ID and the destination ID associated with the first PSSCH and the NDI, the HARQ process number, the source ID and the destination ID associated with the second PSSCH.

18. The method of claim 17, further comprising determining a first CWS for the first UE to perform a first channel access procedure for transmitting the first PSFCH; and
wherein determining the second CWS comprises, when the HARQ process number, the source ID and the destination ID associated with the first PSSCH are respectively the same as the HARQ process number, the source ID and the destination ID associated with the second PSSCH, determining a value of the second CWS by one of the following:
increasing a value of the first CWS to a next allowed CWS value among allowed CWS values for a channel access priority class (CAPC) value associated with the second channel access procedure and setting the value of the second CWS to the increased value when the value of the first CWS is consecutively used by a number of times for performing a channel access procedure; or
setting the value of the second CWS to a minimum allowed CWS value for the CAPC value when the value of the first CWS is a maximum allowed CWS value among the allowed CWS values for the CAPC value and is consecutively used the number of times for performing a channel access procedure.

19. The method of claim 16, further comprising:
receiving, from the second UE, a second sidelink control information (SCI) format scheduling the second PSSCH, wherein the second SCI format includes an indicator indicating whether at least one of previous PSFCHs including the first PSFCH transmitted by the first UE to the second UE in a latest channel occupancy is correctly received by the second UE or not; and
wherein determining the second CWS comprises determining the second CWS based on the indicator in the second SCI format.

20. The method of claim 16, further comprising:
receiving, from the second UE, a second sidelink control information (SCI) format scheduling the second PSSCH, wherein the second SCI format includes an indicator indicating how to adjust the second CWS; and
wherein determining the second CWS comprises determining the second CWS based on the indicator in the second SCI format.
